(19) United States
(12) Patent Application Publication
(10) Pub. No.: US 2016/0174597 A1
(43) Pub. Date: Jun. 23, 2016

(54) FUNCTIONAL FAT FILLED NATURAL MANGO POWDER COMPOSITION AND PRODUCTS MADE THERE OF

(71) Applicant: INTERNATIONAL FOODSTUFFS COMPANY LLC, Sharjah (AE)

(72) Inventors: Virender KUMAR, Sharjah (AE); Mangesh Pandurang VARADE, Sharjah (AE); Appa Baban KAMBLE, Sharjah (AE); Jose Anibal Trujillo QUIJANO, Dubai (AE)

(21) Appl. No.: 14/577,250

(22) Filed: Dec. 19, 2014

(51) Int. Cl. A23L 1/212; A23G 9/42; A23L 2/56; A23L 1/187; A23C 9/13; A23G 9/32; A23C 9/154

(52) U.S. Cl. CPC A23L 1/2121; A23G 9/327; A23G 9/42; A23C 9/154; A23L 1/187; A23C 9/1315; A23C 9/1307; A23L 2/56; A23V 2002/00

(57) ABSTRACT

The present invention relates to a spray dried 20-65% of natural mango pulp base powder which is composed of 21-55% of fat which can be used as an alternative to mango based desserts, soft serve ice creams and fillings. A functional fat filled natural mango powder comprise of 21-55% by weight of fat, 1-5% by weight of one or more proteins, 0.5-5% by weight of one or more emulsifier system, 1.5-2.0% by weight of buffers, 1-5% by weight of water and the balance is made up of non-starchy carbohydrates, antioxidants and stabilizers. Optionally flavor, color and anticaking agents can be supplemented to the composition. The above composition can be used directly or after reconstituted with water, to prepare foods such as desserts, fillings, mango shake. A functional fat filled natural mango powder can be conveniently used to develop processed food products such as soft serve ice cream, mango whipped toppings, mango mousse, mango puddings, kheer, custard, shrikhand, mango lassi.

### BACKGROUND

The present invention pertains to a functional fat filled natural mango powder. Predominantly, the invention relates to a spray dried non-dairy fat with natural mango pulp which on reconstitution with water enables the food manufacturer to rapidly and conveniently create a wide variety of foods such as mango mousses, desserts, filling, mango shake, mango puddings, custards, mango toppings, mango lassi. The powder is easily dispersed in cold and hot water, and product is powdery thus is easier to store and preserve.

The present existing Patents CN102940170A, CN201210473461, CN 103651790 A, CN 201210338247 and the Patent Application W02009028923 A1 and PCT/MX2007/000150 refer only to spray drying of pure Mango Powder which is either pre-blended with other ingredients or use different processes like tray drying etc. Further in all the aforesaid patents the problems of color stability of dry mango powder are not being mentioned. Since surface area is greater and the oxidation takes place which indeed results in the color change from orange to brownish caused due to carotene degradation of dry powder.

A functional fat filled mango powder is a very unique product. This product can be used in many applications like mango shakes, mango whipped toppings, mango puddings, mango mousses, custard, shrikhand and where mango pulp can be replaced. The powdered form of mango has a greater shelf life, good color stability due to oxygen barrier provided by the fat, less logistics and packaging cost over liquid counterpart. Present-day instant re-constituable powdered products are abundantly used in households and food service. This is mainly due to increasing demand for more and more time saving and convenient food preparation methods.

### SUMMARY OF THE SUBJECT MATTER

The invention is functional fat filled natural mango powder which can be used for mango based desserts and soft serve ice cream, fillings, mango shake, mango mousse, mango whipped topping, custard, shrikhand, mango lassi. The powder comprises about 1 to 5% by weight water, about 15 to 60% by weight of fat, about 1 to 5% by weight of one or more proteins, 0.5 to 5% by weight of one or more of emulsifier. Preferably a functional fat filled Natural Mango powder may contain effective amount of stabilizers and buffers. The invention is a functional fat filled natural mango powder product which has good solubility and is able to give rich and creamy taste to finished products like mango shakes, mango whipped toppings, mango puddings, mango mousses, custard, shrikhand and desserts that uses mango pulp or other fruits such as passion fruit, strawberry, papaya and other pulpy fruits.

### DETAILED DESCRIPTION

The spray dried functional fat filled natural mango powder contain about 1-5% water. Preferably containing 2-3% water.

The Functional fat filled natural mango powder composition of the present invention contains about 15 to 60% by weight of an edible fat containing one or more fats, wherein the fat component is preferably solid or semi-solid at room temperature. The fat component can be selected from numerous sources. Preferably the fat component is of animal, vegetable or dairy origin. The refined and deodorized fat component can be selected from plant oils, such as soybean oil, sunflower oil, canola oil, palm oil, palm kernel oil, coconut oil, safflower oil, corn oil, olive oil, peanut oil and cotton seed oil which can be used alone or as a mixture of two or more thereof. Hydrogenated, Fractionated, Interesterified chemically or enzymatically, single or combination of two or more fat used can be selected according to the final use of the powder. The fat should be fortified with antioxidants such as Natural (Tocopherols/Ascorbyl Palmitate) or synthetic ones. Preferably Ascorbyl Palmitate or Oleate can be used at levels of 100-400 ppm.

The fat component having more crystallized fat in low temperature is suitable for product applications such as mango toppings and mousse. Preferably a fat component roughly having 70-93% crystallized fat at 20° C. and 15-38% crystallized fat at 30° C. (measured by pulsed Nuclear Magnetic Resonance according to the AOCS method cd 16693 or IUPAC parallel method 2.150a) is important for overrun and smooth, shiny structure in these products.

Preferably the protein component can be selected from dairy or plant sources. Suitable proteins are derived from Caseinate, whey protein concentrate or isolates, skimmed milk powder (low or high heat), butter milk powder, soy protein concentrate or isolates, wheat proteins and pea protein isolates. Combination of one or more protein is also possible to use in the present invention. Emulsifying plant extracts such as gum Arabic, and modified starches like octenyl succinic acid (OSA) with emulsifying properties can be used along with protein sources to form stable oil in water emulsions.

Preferably fresh mango pulp 20-60% is used in functional fat filled natural mango powder. There are numerous varieties of mangoes present in the world. Each variety has a unique flavor and texture. Mango pulp has a brix 16-25%, Acidity (% as a citric acid) 0.5 to 0.75%, pH 3.0 to 4.5, Consistency (Bostwick cm/30 Sec) 8-12 cm. The Brix, acidity, pH, consistency is different from variety to variety. A fresh mango pulp used in the present invention as required for good quality, flavor characteristics of the finished powder. Used fresh deep color mango pulp and having a typical ripe mango Flavor. Generally mango pulp with mild flavored, firm fleshed mango which can range from purple to yellow skin with an oblong shape gives better result. Mangoes from different regions are different in taste, sweetness, and consistency in flesh, color, Aroma and so many other characteristics.

Ataulfo type of Mango has a very small seed hence high flesh to seed ratio and has Sweet, creamy flavor, smooth firm flesh with no fibers, and vibrant yellow in color. These types of mangoes are found in Mexico.

Tommy Atkins Mango Hailing from Florida is the most widely grown commercial variety coming in to the United States. It has a unique mild and sweet flavor also has a firm flesh. It is found in Mexico, Guatemala, Brazil, Peru, Ecuador.

Alphonso type is an Indian variety and is mild Flavored, firm fleshed mango which can range from purple to yellow skin.

In addition to above types of mangoes following types may be used in Functional fat filled Natural Mango powder like Totapuri, Edword, Kesar, Manila, Palmer, Anderson, Amrapali, Brooks, Beverly, Eldon, Emerlad, haden, Glenn, Neelam, Langra, Saharni, sindhri, Romania, Banganapalli, Francis, Keitt and Kent.

Range of conventional emulsifiers can be used to build the emulsifier system in the products along with the protein component. Examples of conventional emulsifiers are mono and diglycerides of fatty acids, organic acid ester derivatives of mono and diglycerides (Acetic acid esters of mono and diglycerides of fatty acids, Lactic acid esters of mono and diglycerides of fatty acids, Citric acid esters of mono and diglycerides of fatty acids, mono and diacetyl tartacric esters of mono and diglycerides of fatty acids). Other emulsifiers which can be aid in the formation of emulsion are soy lecithin, polysorbate 60, polysorbate 65, polysorbate 80. The usage of combinations of emulsifier is preferable to have better final product properties.

Carbohydrates are bulking agents which encapsulate the emulsified fat during spray drying. Better encapsulated fat imparts rich and creamy taste to powders with better keeping qualities. Carbohydrate usable in the composition preferably comprises of corn syrup solids, Malto-dextrin 10 to 19 DE range (dextrose equivalent), Sucrose, fructose, dextrose and maltose.

Emulsion stabilizers are used in present invention to aid in solubility, emulsion stability and maintenance of pH. Preferably chemical stabilizers are used in the invention. The chemical stabilizers may comprise sodium phosphate, potassium phosphate and sodium citrate. The sodium phosphate and potassium phosphate are most preferred emulsion stabilizers in the present invention.

The Functional fat filled natural Mango powder of the present invention does not include any artificial flavors to provide dairy or mango like flavor. Flavors in liquid form can be added to the prepared emulsions prior to spray drying, or dried form can be dry blended into powders. Preferably salt is used to enhance the flavor.

The powder composition of the present invention may also include optional additives typically used in spray dried food powder compositions such as anticaking agents. The preferred anticaking agents are tri calcium phosphate and silicon dioxide in the present invention. The additives are added in varying amounts, typically about 0.01-5% of the powder.

Preferably, A functional fat filled natural mango powder (Table 1) according to the present invention comprises the following components in the emulsion prior to spray drying and in the final powder:

| | % emulsion | % powder |
|---|---|---|
| | Before spray | After spray |
| Ingredient | drying | drying |
| Vegetable fat or dairy fat or animal fat | 10-40 | 20-60 |
| With antioxidants | | |
| Maltodextrin/Corn syrup solids/sucrose | 10-30% | 10-50% |
| Milk Protein/Soy Protein/Pea Protein | 1-3% | 1-5% |
| Stabilizer/Acidity Regulators | 0.5-3% | 1.5-3% |
| Salt | 0.1-1% | 0.1-1% |
| * anticaking agents | 0.1-1% | 0.1-0.5% |
| Water | Balance to 100 | 2-5% |

* and anticaking agents can be dry blended after spray drying

Another aspect of the invention is a process for the preparation of a powdered functional fat filled natural mango powder following above mentioned emulsion formulation. The process comprising the steps of:
a. Preparation of water phase using water soluble ingredients;
b. Preparation of fat phase with melted fat & fat soluble/dispersible ingredients;
c. Addition of fat phase to the water phase and forming oil in water emulsion (approximately solid content about 40 to 50% by weight);
d. Two-stage homogenization (first stage: about 500 psi; second stage: about 2000 psi);
e. Pasteurization of the emulsion and optional addition of liquid flavor compounds;
f. Spray drying the emulsion in a multi-stage spray dryer at an inlet temperature of 200° C. and outlet temperature of 75° C. After the first stage of drying under the chamber powders are further dried and cooled on a moving belt until they reach temperature roughly below 25° C.;
g. The powders are conditioned at 8° C. for 24 hours and
h. Subsequently stored at 20° C.

The prepared Functional fat filled natural Mango powder emulsion has 40-50% solid content and the emulsion is spray dried in a multi-stage spray dryer under pressure nozzle atomization. The viscosity of the emulsion should appropriate for spray drying under nozzle atomization. Too thick emulsions result in poor atomization and powders with inappropriate particle sizes.

A 100 Kg quantity of Functional fat filled natural Mango powder was produced by spray drying. The resulting product is a yellow color free flowing powder with a 20-40% fat content and 3% moisture content. The Functional fat filled natural Mango powder is a unique product which has good solubility and smooth, rich taste.

The one part of above product was rehydrated with equal amount of water, and tested for the performance. The rehydrated product rapidly dissolves in both cold and hot water forming mango juice solution. The product was stable in cooking applications at 90° C. for 10 minutes, A Functional fat filled Natural Mango powder has outstanding stability. The appropriately packaged and stored product has a shelf life of 1 year at 20 Degree Centigrade.

The desired quantity of Functional fat filled natural Mango powder may be add into Mango shakes, puddings, custards, fillings, soft serve ice creams in order to get rich creamy mango taste and thickness. The powder can be added directly or after reconstitute with water to get a desirable creaminess. It is often preferable to use reconstituted powder for above mentioned food preparations.

The following examples are used to illustrate the present invention used to develop processed products, but should not be limited thereto.

### BRIEF DESCRIPTION OF THE TABLES

Table 1 shows contemplated composition of functional fat filled natural mango powder in the form of an emulsion prior to spray drying, and in the final powder.

Table 2 shows contemplated composition of a mango shake prepared using functional fat filled natural mango powder.

Table 3 shows contemplated composition of a mango soft serve ice cream prepared using functional fat filled natural mango powder.

Table 4 shows contemplated composition of a milk based mango pudding prepared using functional fat filled natural mango powder.

Table 5 shows contemplated composition of a mango whip topping prepared using functional fat filled natural mango powder.

Table 6 shows contemplated composition of a mango mousse prepared using functional fat filled natural mango powder.

Table 7 shows contemplated composition of a mango lassi prepared using functional fat filled natural mango powder.

Table 8 shows contemplated composition of a mango filling prepared using functional fat filled natural mango powder.

### EXAMPLES

### Example 1

A Mango Shake was prepared on the basis of the following recipe (Table 2):

| | Wt % |
|---|---|
| Functional fat filled Natural | 40% |
| Mango powder (20-40% fat | |
| and 40-60% Mango Pulp) | |
| Sucrose | 12% |
| Starch | 0.1-4% |
| Flavor, color | 0.1 To 1% |
| | (Optional) |
| Pista, keshar, ice cubes | optional |
| Balance with Water or Milk | 45-50% |

A dry mix for making a Mango shake is prepared following above formulation. All the dry components are mixed together by hand in a container for few seconds. After adding cold milk or cold water, the mixture is beaten using a kitchen aid mixture. At first mix in a medium speed for 1 min to allow all the contents to mix properly with water. After that according to preference add pista, keshar and ice cubes. The product obtained has a desirable mouth feel and texture, and capable of giving rich, smooth taste.

In order to prepare regular Mango shake, Functional fat filled Natural Mango powder, starch, Sugar and flavor can be blended to form the product. In the case of sugar free Mango shake instead of sugar appropriate combinations of natural or artificial sweeteners can be used.

### Example 2

A Mango Soft serve Ice cream product was prepared according to the following recipe (Table 3):

| | Wt % |
|---|---|
| Functional fat filled Natural | 20% |
| Mango powder (20-40% fat | |
| and 40-60% Mango Pulp) | |
| Sucrose | 12% |
| Skimmed Milk Powder | 5% |
| Stabilizer & Emulsifies | 2-3% |
| Starch | 2% |
| Flavor, color | 0.1 To 1% (Optional) |
| Balance with Water or Milk | 63-68% |

All the dry ingredients are added under stirring to the chilled water and blended using a hand blender to dissolve completely. Since the Functional fat filled Natural Mango powder has a good solubility in cold water, there is no need to use hot water to dissolve it. Preferably this solution can be pasteurized at 82° C. for 20 seconds and cooled to 20° C. A further cooling of the mixture can be carried out in refrigerator until temperature reaches below 4° C. The cold mixture is aerated using a soft serve ice cream machine to the desired overrun and temperature.

The product obtained is capable of an overrun about 25 to 45% depend on the aeration capability of soft serve ice cream machine. Homogenization or aging of the mixture is not required. The obtained soft serve product has pleasant eating qualities and meltdown properties.

Alternatively if fresh skimmed or full fat milk are available they can be used instead of milk powder and water.

### Example 3

A Milk based Mango pudding was prepared on the basis of the following recipe (Table 4):

| | Wt % |
|---|---|
| Functional fat filled Natural | 25% |
| Mango powder (20-40% fat | |
| and 40-60% Mango Pulp) | |
| Sucrose | 15% |
| Skimmed Milk Powder | 3% |
| Starch | 8% |
| Flavor, colour | 0.1-1% |
| Water balance | 50-55% |

The above components were added under stirring to the water at room temperature until all the ingredients are dissolved completely. The mixture is heated for few minutes until thickens and coat back of a metal spoon. The thickened mixture is poured into containers and cooled in refrigerator for one hour.

The obtained product has a pleasant smooth, spoon able and creamy texture. The product does not show syneresis when stored at refrigerated temperature for 2 days.

### Example 4

A Mango whip Topping was prepared on the basis of the following recipe (Table 5):

| | Wt % |
|---|---|
| Functional fat filled Natural | 40% |
| Mango powder (20-40% fat | |
| and 40-60% Mango Pulp) | |
| Sucrose | 12% |
| Stabilizer/Emulsifier | 0.1-3% |
| Starch | 0.1-4% |
| Flavor, color | 0.1-1% |
| Water balance | 45-50% |

A dry mix for making a Mango whipped topping is prepared following above formulation. All the dry components are mixed together by hand in a container for few seconds. After adding cold milk or cold water, the mixture is beaten using a kitchen aid mixture. At first whip in a slow speed for 1 min to allow all the contents to mix properly with water. After that whip the mixture in a high speed about 5 to 6 minutes until topping thickens and forms light fluffy peaks.

### Example 5

A Mango Mousse product was prepared using Functional fat filled Natural Mango powder (20-40% fat and 40-60% Mango Pulp) according to the following recipe (Table 6):

| | Wt % |
|---|---|
| Functional fat filled Natural | 13% |
| Mango powder (20-40% fat | |
| and 40-60% Mango Pulp) | |
| Sucrose | 18% |
| Skimmed Milk Powder | 5% |
| Starch | 5% |
| Salt, flavor, colour | 0.1-1% |
| Water/Milk | Balance |

The above components were added under stirring to the water at room temperature until all the ingredients are dissolved completely. Above mixture is further cooled and whipped using a kitchen aid mixer to approximately 100% overrun, followed by refrigeration at 5° C. for few hours.

The resulting product has a smooth spoon able texture similar to conventional mousse dessert prepared by gelatin or egg. Preferably the mousse product can be served with whipped topping prepared with cream base powder, and garnished with chopped chocolate.

### Example 6

A Mango Lassi product was prepared using Functional fat filled Natural Mango powder (20-40% fat and 40-60% Mango Pulp) according to the following recipe (Table 6):

| | Wt % |
|---|---|
| Functional fat filled Natural | 30-40% |
| Mango powder (20-40% fat | |
| and 40-60% Mango Pulp) | |
| Yoghurt/Dahi | 20-30% |
| Sugar | 10% |
| Salt, flavor, colour | 0.1 To 1% (Optional) |
| Water or Milk | (Optional) |

The above components were added under stirring the water at room temperature until all the ingredients are dissolved completely. Above mixture is further cooled and well mixed by using Hand Blender and followed by refrigeration at 5° C. for few hours.

The resulting product has a smooth Creamy texture and gives real Natural Mango flavor.

### Example 7

A Mango Filling for Pralines, Biscuits, and Wafers product was prepared using Functional fat filled Natural Mango powder (20-40% fat and 40-60% Mango Pulp) according to the following recipe (Table 6):

| | Wt % |
|---|---|
| Functional fat filled Natural | 20-30% |
| Mango powder (20-40% fat | |
| and 40-60% Mango Pulp) | |
| Sugar | 25-45% |
| Structured Vegetable fat | 28-35% |
| Lactose | 3-8% |
| Soya lecithin | 0.1 to 0.5% |
| Beta Carotene | 0.001 to 0.5% |

Mix above ingredients and refine on roller mill/Ball mill to less than 30 micron for smooth textured end product. Fat used in this product is structured, interesterified fat from vegetable or animal origin. The fat used in this Mango filling has slip melting point 32° C. with SFC at 20° C. is 34.2, At 30° C. is 7.8, At 35° C. is 0.5. This Mango filling is widely used in Praline, Biscuits, and Wafers. Controlled cooling is highly recommended for depositing this type of premium filling. This helps in improved appeal, better shelf life, desired gloss and adherence.

1. A functional fat filled natural mango powder (20-40% fat and 40-60% mango pulp) composition comprising:
20 to 60% by weight fat,
20-60% by weight mango pulp,
2 to 5% by weight protein,
0.5-5% by weight emulsifier, and
1-5% by weight water.

2. The functional fat filled natural mango powder (20-40% fat and 40-60% mango pulp) of claim 1 further comprising 0.1-5% of an effective amount of stabilizer and an effective amount of buffering agents, wherein the stabilizer and the buffering agents are selected from Di-sodium phosphate, Di-potassium phosphate and sodium citrate.

3. The functional fat filled natural mango powder (20-40% fat and 40-60% mango pulp) of claim 1 comprising flavor enhancers such as salt.

4. The functional fat filled natural mango powder (20-40% fat and 40-60% mango pulp) composition of claim 1 comprising 0.1-2% of anticaking agents.

5. The functional fat filled natural mango powder (20-40% fat and 40-60% mango pulp) composition of claim 1 comprising 20% to 60% by weight mango pulp, wherein mangoes used in the fat filled mango powder are selected from Alampur, Alphonso, Amrapali, Anderson, Angie, Anwar Baneshan, Alice, Ratol, Ataulfo, Baileys Marve, Banganapalle, Totapuri, Sindhri, Valencia Pride, Langra, Palmer, Parvin, Gold Nugget, Dasheri, Chaunsa, and Bennet Alphonso.

6. The functional fat filled natural mango powder (20-40% fat and 40-60% mango pulp) composition of claim 1, wherein the fat is selected from animal, marine, plant and dairy origin, wherein, when the fat is selected from the plant origin, plant oils are selected from soybean oil, sunflower oil, canola oil, palm oil, palm kernel oil, coconut oil, safflower oil, corn oil, olive oil, peanut oil, cotton seed oil and a combination of several of the plant oils.

7. The functional fat filled natural mango powder (20-40% fat and 40-60% mango pulp) composition of claim 6, wherein the plant oils are modified following complete or partial hydrogenation, fractionation and interesterification.

8. The functional fat filled natural mango powder (20-40% fat and 40-60% mango pulp) claim 1, wherein one or more of the protein is selected from caseinate, whey protein concentrate or isolates, non-fat dry milk (low or high heat), butter milk powder, soy protein concentrate or isolates, wheat proteins and pea protein isolate, gum arabic and modified starch with emulsifying properties.

9. The functional fat filled natural mango powder (20-40% fat and 40-60% mango pulp) claim 1, wherein one or more of the emulsifier is selected from mono and Di-glycerides of fatty acids, organic acid ester derivatives of mono and diglycerides (acetoglycerides, lactoglycerides, citroglycerides, diacetyl tartacric esters of monoglycerides), soy lecithin, polysorbate 60, polysorbate 65, and polysorbate 80.

10. The functional fat filled natural mango powder (20-40% fat and 40-60% mango pulp) claim 1, wherein one or more non-starchy carbohydrate bulking agent is selected from sucrose, corn syrup solids, malto-dextrin 10 to 19 dextrose equivalent range, fructose, dextrose and maltose.

11. A soft serve ice cream product prepared by mixing the product defined in claim 1 as the functional fat filled natural mango powder (20-40% fat and 40-60% mango pulp) with other ingredients, wherein the product obtained through the soft serve ice cream machine has an overrun of about 20-40% and good melt down properties, wherein a starch component is selected from native corn starch or cross linked modified starch having thickening ability, and wherein sources of the starch include corn, potato, tapioca, maize, wheat, rice and sorghum.

12. The functional fat filled natural mango powder (20-40% fat and 40-60% mango pulp) claim 1, wherein the composition comprising the steps of dissolving all dry ingredients in the water phase, dissolving all the fat soluble/dispersible components in the fat phase, mixing fat phase with water phase, two stage homogenization to form oil in water emulsion, pasteurization and spray drying in a multi-stage spray dryer through nozzle atomization.

13. The functional fat filled natural mango powder (20-40% fat and 40-60% mango pulp) of claim 1, wherein the composition is rapidly soluble in cold and hot water forming a milky solution, wherein after rehydration with water to have a 1 to 1 ratio, the product of claim 1 is stable for at least 10 minutes at 90° C.

14. A mango milk shake product prepared by mixing the product defined in claim 1 as the functional fat filled natural mango powder (20-40% fat and 40-60% mango pulp) with other ingredients, wherein the product obtained through a mixer/machine has a great taste, and a pleasant flavor.

15. A soft serve ice cream product prepared by mixing the product defined in claim 1 as the functional filled natural mango powder (20-40% fat and 40-60% mango pulp) with other ingredients, wherein the product obtained through a soft serve ice cream machine has an overrun of about 20-40% and good melt down properties.

16. A milk based mango pudding product prepared by mixing the product defined in claim 1 as a fat base with other ingredients, wherein the heated product has a smooth and creamy texture with good freeze thaw stability.

17. A mango whip topping product prepared by mixing the product defined in claim 1, which is the functional fat filled natural mango powder (20-40% fat and 40-60% mango pulp) mixed with other ingredients, wherein the resulting mango whip topping product has an overrun of about 200-250%.

18. A mango mousse product prepared by mixing the product defined in claim 1, which is prepared by the functional fat filled natural mango powder (20-40% fat and 40-60% mango pulp) mixed with other ingredients.

19. A mango lassi product prepared by mixing the product defined in claim 1, which is prepared by the functional fat filled natural mango powder (20-40% fat and 40-60% mango pulp) mixed with other ingredients.

20. A mango filling product prepared by mixing the product defined in claim 1, which is prepared by the functional fat filled natural mango powder (20-40% fat and 40-60% mango pulp), which is for use in praline fillings, biscuits, and wafers.
